(19) United States
(12) Patent Application Publication
(10) Pub. No.: US 2008/0263644 A1
(43) Pub. Date: Oct. 23, 2008

(54) FEDERATED AUTHORIZATION FOR DISTRIBUTED COMPUTING

(76) Inventor: Doron Grinstein, Valley Village, CA (US)

Correspondence Address: BITKOO, LLC;ATTN: DORON GRINSTEIN, P.O. BOX 4867, VALLEY VILLAGE, CA, 91617, US

(21) Appl. No.: 11/738,952

(22) Filed: Apr. 23, 2007

(51) Int. Cl. H04L 9/32

(52) U.S. Cl. 726/6

(57) ABSTRACT

Distributed computing systems can exchange authorization information in a manner which alleviates the need for a receiving system to utilize any external systems when making an authorization decision. The trusted authorization provider can digitally sign authorization snippets of information. The requestor sends the digitally signed authorization snippet with the request. Because both computing processes trust the same authorization provider, the servicer of the request is able to grant or deny access in a completely autonomous fashion without having to rely on external resources for authorization. A requesting process can determine the digitally signed authorization snippet corresponding with the request. The servicing process can rely on the digitally signed authorization snippet to perform the authorization.

### BACKGROUND

In order to support a scalable, distributed computing environment, security is paramount. Security is based on authentication (“who is the subject?”) and authorization (“what is the subject allowed to do?”).

Traditionally, centralized identity management solutions were created to address user security when the user and the resources the user accessed were within the same network, or at least were within the same domain of control. Increasingly however, users are accessing external resources outside their domain of control, and external users are accessing internal resources. The challenges associated with cross-company, cross-domain issues has given rise to a new approach to identity management, known as “federated identity management”. The ultimate goal of identity federation is to enable users of one domain to be securely identified by another domain seamlessly, without the need for redundant user administration. For example, suppose a person wanted to book a seat on an airline and also wanted to register as a guest in a hotel. By using the same federated identity management system, the airline and the hotel agree to trust each other's authentication of the user. The person would thus be able to identify himself once when booking his flight and this authenticated identity would be carried over to be used for reservation of a hotel room. In recent years a number of standards have emerged to address the problems that arise in the implementation of federated identity management. These standards include SAML, XACML, WS-Security, OpenID, WS-Federation, WS-Trust, Cardspace, the Higgins trust framework, Novell's Bandit project and others.

But while companies and organizations have devoted considerable attention to the issues of federated identity, to fully realize the possibilities and benefits of distributed computing, a robust and scalable means for federated authorization is also necessary. In a single organization a central authorization system is possible, but a central authorization system is not practical in large public networks like the Internet. The large number of organizations involved, many having very different interests, make it unlikely that they would share a central authorization system. In contrast, a federated authorization environment would enable multiple systems controlled by different organizations to be able to securely request services and to provide services without the need for a central authorization system. To date, however, no federated authorization solution is known.

### SUMMARY

A cross-process mechanism allows for the federation of authorization metadata to enable multiple systems optionally controlled by different organizations to be able to securely request services and to provide services without the need to access a central authorization system or authority. Federation of authorization decisions enables inter-process calls between a calling process and a called (servicing) process on the same computer or on different computers, within the same domain or in different domains and within the same organization or in different organizations, without requiring the servicing process to consult external resources for authorization decisions or for verification of caller authorizations. Sufficient authorization information for a subject is sent to a receiving process utilizing public key/private key or symmetric key infrastructure and cryptographic algorithms based on keys, so that the receiving process does not have to consult external processes or systems to determine whether to permit or deny a request made by the subject.

An authorization policy service may receive a request for authorization metadata for a subject. The authorization policy service may consult internal and/or external systems to determine the operations, actions and permissions that can be given to the subject. From this information, the authorization policy service assembles an authorization assertion. The authorization assertion is comprised of authorization metadata associated with the subject in a specified context. A context may be an application, a service, an executable, an organization, etc. Each sub-element or group of sub-elements in the authorization assertion may be digitally signed by the authorization policy service. After the authorization policy service returns the authorization assertion to the requesting process acting on behalf of a subject, a specific individual signed sub-element or authlet can be extracted from the authorization assertion by the process acting on behalf of the subject. The signed sub-element can be used as a virtual key that is packaged or sent with a request for service to another process. That is, the signed sub-element for the particular access request desired by the subject may be extracted from the authorization assertion and may be sent to the receiving (servicing) process as the subject's granular authorization key for the particular action, data, resource, etc. When the servicing process receives the virtual key, the servicing process is able to determine whether to allow or deny access autonomously (without having to consult an external authorization system). Each signed sub-element (also referred to as a signed authorization snippet or authlet) represents a virtual key for the subject/context unit. Because the authorization assertion includes autonomous, digitally signed sub-elements that can be verified individually, a servicing process that trusts the authorization policy service can verify that the authlet was signed by a trusted authorization policy service and thus, the servicing process can autonomously determine whether to grant or deny access to the subject based on the trusted authlet contents.

### BRIEF DESCRIPTION OF THE DRAWINGS

In the drawings:

FIG. 1a is a block diagram illustrating an exemplary computing environment in which aspects of the invention may be implemented;

FIG. 1b is a block diagram illustrating an exemplary networking environment in which aspects of the invention may be implemented;

FIG. 2a is a flow diagram of a method of federated authorization in accordance with some embodiments of the invention;

FIG. 2b is a block diagram of an exemplary federated authorization system in accordance with embodiments of the invention;

FIG. 3 is a block diagram of an exemplary system for establishing a trust relationship with the authorization policy service in accordance with embodiments of the invention;

FIG. 4 illustrates an authorization assertion data structure in accordance with embodiments of the invention; and

FIG. 5 illustrates an authlet envelope data structure in accordance with embodiments of the invention.

### DETAILED DESCRIPTION

### Overview

A high degree of scalability and performance in distributed computing can be realized through the creation of a federated authorization environment. Federated authorization can improve the scalability of distributed computing by allowing an unlimited number of computers to autonomously verify the validity of authorization assertions without having to consult a central authorization repository and may improve performance in distributed computing by eliminating the need for a receiving process to access an external source (such as an authorization service) to make authorization determinations for a requesting process's request.

A receiving (servicing) process is able to autonomously determine whether to grant or deny a request received from a requesting process for access to a resource, without accessing an authorization service or other external resource because of a trust relationship that exists between the receiving process and an authorization policy service. A resource may be a piece of data, a location on a hard disk, a function or any type of information. The computer hosting the receiving process may be completely disconnected from any other system or network and still be able to autonomously make authorization decisions about requests being made of it. Alternatively, the receiving process may be hosted by a server in a server farm. For example, the trust relationship between the receiving process and the authorization policy service may be based on encryption/decryption algorithms that rely on asymmetric or symmetric keys. For example, a receiving process may trust the authorization service because it has the authorization service's public key registered or may trust the authorization service because the authorization service's public key is included in a trusted certificate chain. The request received from the requesting process may include sufficient data to enable the receiving process to determine if the request should be granted or denied. The request may include a self-contained signed data fragment that can be presented from a subject or on the subject's behalf with the request for an action, operation or data resource of a receiving (servicing) process that services the request. For example, metadata concerning authorizations for the subject and context may be digitally signed and/or encrypted by the trusted authorization policy service using a private key of a public-private key pair, placed in an authorization assertion and sent to the computing process acting on behalf of the subject. The encrypted and/or signed metadata may include the public key of the public-private key pair of the signer. When the computing process acting on behalf of the subject submits a request for data or for an operation or action on a resource on a second process on the same computer or on a different one, the computing process acting on behalf of the subject may extract the appropriate signed metadata fragment from the authorization assertion and send the signed authorization metadata fragment along with the request to the servicing process. When the request is received by the servicing process, it, by virtue of a trust relationship with the authorization provider, can verify the digital signature of the authorization metadata fragment included in the request and autonomously make a determination of whether access should be granted or denied. The trust relationship between the servicing process and the authorization provider may be established by registering the public key of the authorization provider public/private key pair with the servicing process. Other ways to establish a trust relationship between the authorization provider and the servicing processes include registering a certificate authority with the servicing process. In this case, trust may be verified by the servicing process by following the certificate trust chain all the way to the certification authority. Although a digital signature may be used, other techniques such as encryption may also be utilized as long as the servicing process can verify that only the holder of the signer encryption key could possibly encrypt and/or sign the authorization metadata fragment.

To receive an authorization assertion, an application, such as but not limited to a rich-client application running on a client may collect authentication information from a user and request a token from an authentication service. A token is typically used to represent the credentials or security information known about an authenticated user or subject so that the subject can access remote systems without the need for re-authentication. The subject may be a person, a role, a computer system, a computing process, a computing machine, an application or other entity. The process acting on behalf of the authenticated subject may send a request to an authorization policy service for an authorization assertion. The process acting on behalf of the subject may require authorization metadata in order to request access to or be given access to data or other resources either in the same process or in a different process (on the same computer or on different computers). Authorization in this context refers to the level of access granted to the subject. The level of access may be very simple (e.g., “can access this data” or “cannot access this data”) or may be relatively complex (e.g. “can format drive G between the hours of 14:00 and 16:00 on Saturdays between Apr. 10, 2007 and Dec. 25, 2007 while authentication source is Directory X and if drive G contains less than 10 GB of data”. Authorization is thus a description represented by a collection of bytes understood by both the authorization policy service and the system making the decision to grant or deny a request for service. The authorization assertion thus may be encoded in any language understood or translatable by the collaborating systems including, but not limited to XACML, SAML, etc., as well as any other authorization languages as they emerge, decline and mutate.

When a request is made to the authorization policy service for an authorization assertion, the authorization policy service may consult internal and/or external systems to determine the operations and actions that the requesting subject can perform and the permissions that can be given to the subject. For example, within the context of a payroll application, perhaps the subject can perform payroll calculations, can press button1, can read file 123.xyz, etc. The authorization policy service may assemble an authorization assertion for the subject from this information. The authorization assertion may be an electronic document comprised of authorization metadata associated with the subject for a particular context or contexts. The context may be an application, a physical location, a time of day, etc. The authorization assertion may include one or more sub-element or groups of sub-elements representing authorization metadata. For example, an authorization assertion may list the resource and the operations or actions that the subject is allowed to perform on the resource. A simplified plaintext sample of authorization metadata is reproduced in XML below. It will be appreciated that the example may be generated in XACML or in any other well known or future schema language and is provided here in simplified form for ease of understanding only.

```
<AuthorizationAssertion>
  <(more data here to represent other information such as
  authentication data)>
<authorization_fragment>
  <resource>
    bitkoo.com/application1/operation/issue_check
  </resource>
  <permissions execute=“true” />
</authorization_fragment>
<authorization_fragment>
  <resource>
    bitkoo.com/application/resource/stored_procedure_save_employee
  </resource>
  <permissions execute=“true” />
</authorization_fragment>
</AuthorizationAssertion>
```

In the first authorization data fragment, the resource is identified as bitkoo.com/application1/operation/issue_check. The subject is permitted to execute (i.e., “execute=“true””) the issue_check operation. The second authorization data fragment identifies the resource as bitkoo.com/application/resource/stored_procedure_save_employee. The subject is permitted to execute (i.e., “execute=“true””) the stored procedure “stored_procedure_save_employee”. The above sample authorization assertion includes two authorization fragments or sub-elements, although it will be appreciated that an authorization assertion can include any number of sub-elements or groups of sub-elements. Each sub-element may be digitally signed by the authorization policy service, using a digital signature algorithm to create an authlet. For example, a sub-element may be signed using the private key of a public/private key pair, although in other embodiments of the invention, it may be signed using the public key of a public/private key pair or using a symmetric key. A sample simplified representation of the authorization assertion that includes the digital signatures and public keys provided by the authorization policy service for each authorization data fragment is reproduced below:

```
<?xml version=“1.0” encoding=“UTF-8”?>
<!--Sample Authorization Assertion containing Authlets)-->
<!--Copyright 2007 BiTKOO, LLC)-->
<AuthorizationAssertion xsi:noNamespaceSchemaLocation=“authlet.xsd”
xmlns:xsi=“http://www.w3.org/2001/XMLSchema-instance”>
  <AuthenticationData>Authentication data goes here. It may be comprised of SAML or
any other authentication conveying language </AuthenticationData>
  <Authlets>
  <AuthletEnvelope name=“bitkoo.com/application1/operation/issue_check”>
    <Authlet>
<Base64Authlet>MIIDtQYJKoZIhvcNAQcCoIIDpjCCA6ICAQExCzAJBgUrDgMCGg
UAMIH3BgkqhkiG9w0BBwGggekEgeY8AGEAdQB0AGgAbABlAHQAPgA8AHIAZ
QBzAG8AdQByAGMAZQA+AGIAaQB0AGsAbwBvAC4AYwBvAG0ALwBhAHAA
cABsAGkAYwBhAHQAaQBvAG4AMQAvAG8AcABlAHIAYQB0AGkAbwBuAC8A
aQBzAHMAdQBlAF8AYwBoAGUAYwBrADwALwByAGUAcwBvAHUAcgBjAGU
APgA8AHAAZQByAG0AaQBzAHMAaQBvAG4AcwAgAGUAeABlAGMAdQB0AG
UAPQAiAHQAcgBlAGUAIgAgAC8APgA8AC8AYQBlAHQAaABsAGUAdAA+AK
CCAcIwggG+MIIBaKADAgECAhATnHCUg94/l09Pedmr8D3gMA0GCSqGSIb3DQE
BBAUAMBYxFDASBgNVBAMTC1Jvb3QgQWdlbmN5MB4XDTA3MDQxMDE3M
DQyN1oXDTM5MTIzMTIzNTk1OVowGTEXMBUGA1UEAxMOTWVzc2FnZVNpZ
25lcjEwgZ8wDQYJKoZIhvcNAQEBBQADgY0AMIGJAoGBALoc9YH78Bp6ROagw3
Ti5xj6u1kRGJ/8R1IIdHRFfNfkoaz3YfuW7JxcbZIn6Jo1TpzXDwVBMx9DEjd3FBVpgl
dkH3nktPXgwpIov2x4YOMQ3gB0CP/f3t7nUbihnI8jc8M1/5d2N+KyNtu3Pz0gRLrF21
PewXq3aQM5gDI8CECpAgMBAAGjSzBJMEcGA1UdAQRAMD6AEBLkCS0GHR1P
AI1hIdwWZGOhGDAWMRQwEgYDVQQDEwtSb290IEFnZW5jeYIQBjdsAKoAZIoR
z7jUqlwl9DANBgkqhkiG9w0BAQQFAANBADtvyAluK1kpXv8WrWsgnHcjqrWLfW
wRjJknJkjyVDQ9lcp4Yycu4RT48BSMZpSoQqJcnqb9VXshMYhrmRVCsvwxgc8wgcw
CAQEwKjAWMRQwEgYDVQQDEwtSb290IEFnZW5jeQIQE5xwlIPeP5dPT3nZq/A9
4DAJBgUrDgMCGgUAMA0GCSqGSIb3DQEBAQUABIGADr+qvuCsioeOnIjFDvW8
8TDgCDc1vqRbg59YgORNCLLquXylTX/CmY1v7X4ytXFjB9FCOwlzI/hLPEs1hO3a
RoN8Sl7o0HHuNapk68iZox5DFqSmzUSrEab1wKI57aPYZ6bLLcULQVBFaU7pc6l0H
kgHE6Lsm/Qdj2E3J7b0EU8=</Base64Authlet>
    </Authlet>
  </AuthletEnvelope>
  <AuthletEnvelope
name=“bitkoo.com/application/resource/stored_procedure_save_employee”>
  <Authlet>
<Base64Authlet>MIID2gYJKoZIhvcNAQcCoIIDyzCCA8cCAQExCzAJBgUrDgMCGg
UAMIIBGwYJKoZIhvcNAQcBoIIBDASCAQg8AGEAdQB0AGgAbABlAHQAPgA8A
HIAZQBzAG8AdQByAGMAZQA+AGIAaQB0AGsAbwBvAC4AYwBvAG0ALwBhA
HAAcABsAGkAYwBhAHQAaQBvAG4ALwByAGUAcwBvAHUAcgBjAGUALwBz
AHQAbwByAGUAZABfAHAAcgBvAGMAZQBkAHUAcgBlAF8AcwBhAHYAZQBf
AGUAbQBwAGwAbwB5AGUAZQA8AC8AcgBlAHMAbwBlAHIAYwBlAD4APAB
wAGUAcgBtAGkAcwBzAGkAbwBuAHMAIABlAHgAZQBjAHUAdABlAD0AIgB0A
HIAdQBlACIAIAAvAD4APAAvAGEAdQB0AGgAbABlAHQAPgCgggHCMIIBvjCC
AWigAwIBAgIQE5xwlIPeP5dPT3nZq/A94DANBgkqhkiG9w0BAQQFADAWMRQw
EgYDVQQDEwtSb290IEFnZW5jeTAeFw0wNzA0MTAxNzA0MjdaFw0zOTEyMzEy
MzU5NTlaMBkxFzAVBgNVBAMTDk1lc3NhZ2VTaWduZXIxMIGfMA0GCSqGSIb3
DQEBAQUAA4GNADCBiQKBgQC6HPWB+/AaekTmoMN04ucY+rtZERif/EdSCHR
0RXzX5KGs92H7luycXG2SJ+iaNU6clw8FQTMfQxI3dxQVaYJXZB955LT14MKSK
L9seGDjEN4AdAj/397e51G4oZyPI3PDNf+Xdjfisjbbtz89IES6xdtT3sF6t2kDOYAyPAh
AqQIDAQABo0swSTBHBgNVHQEEQDA+gBAS5AktBh0dTwCNYSHcFmRjoRgwFj
EUMBIGA1UEAxMLUm9vdCBBZ2VuY3mCEAY3bACqAGSKEc+41KpcNfQwDQY
JKoZIhvcNAQEEBQADQQA7b8gJbitZKV7/Fq1rIJx3I6q1i31sEYyZJyZI8lQ0PZXKeG
MnLuEU+PAUjGaUqEKiXJ6m/VV7ITGIa5kVQrL8MYHPMIHMAgEBMCowFjEUM
BIGA1UEAxMLUm9vdCBBZ2VuY3kCEBOccJSD3j+XT0952avwPeAwCQYFKw4D
AhoFADANBgkqhkiG9w0BAQEFAASBgHhCwAEJkG5qrisgJ2WHGRygISpuhOn+36
Bw6RQKYQPQgwx0jTnHZqYzQS8qGSmv7dRFzKe1CLBd9Ep/Hiax0v/5SHLLyOrna
Z5dFGlPVmmUFG32yrRDbm07Gp8na2YVcv+3tYSdG2Cx8isD++BG5pPvsh7JMXu9o
WjuO8Ubjxga</Base64Authlet>
      </Authlet>
    </AuthletEnvelope>
  </Authlets>
</AuthorizationAssertion>
```

The base64 encoded set of characters between each pair of <Authlet> and </Authlet> tags represents a digitally signed encoding of the <authorization_fragment> data in the plaintext authorization assertion above. The signed authorization may include the resource name, the permission metadata set associated with the resource, valid from and valid to data, public key (private key or symmetric key may be utilized in alternative embodiments) and other values that may be required by the servicing process to be assured that the authlet has originated from a trusted source and that the values encoded within the authlet are still valid.

The authlets in the above-reproduced authorization assertion are embedded within an optional authlet envelope element delimited by the <AuthletEnvelope> (in this example) and </AuthletEnvelope> tags. The envelope element may provide queryable information to the requesting process. In the above example, the authlet envelope includes the plaintext name of the resource to be executed by the servicing process (e.g., “bitkoo.com/application1/operation/issue_check” for the first authlet and “bitkoo.com/application/resource/stored_procedure_save_employee” for the second authlet. By having a plaintext or other queryable representation of the resource within the authorization assertion, a subject or computing process acting on behalf of the subject can traverse the assertion (whether cached in memory or persisted on a stable data storage medium) and extract and send only the authlet that is required in order to perform the desired operation. Because the entire authorization assertion could be very large, sending the entire authorization assertion is likely to consume more bandwidth and processing cycles and add unnecessary latency in the processing of the request for both the requester of service and the provider of service than sending only the authlet corresponding to the operation request.

It will be appreciated that the authorization assertion document thus includes autonomous, digitally signed elements that can be verified individually. Any servicing process that trusts the authorization policy service can verify that the signed data fragment or authorization snippet (authlet) was signed by the trusted authorization policy service and the servicing process can grant or deny access to the caller based on the trusted authlet contents. That is, the signed data fragment may be used as a virtual key that is packaged with or sent with a request for service to another process. When the receiving process receives the virtual key authlet it will be able to determine whether to allow or deny access autonomously without the need to consult an external authorization system.

### Exemplary Computing Environment

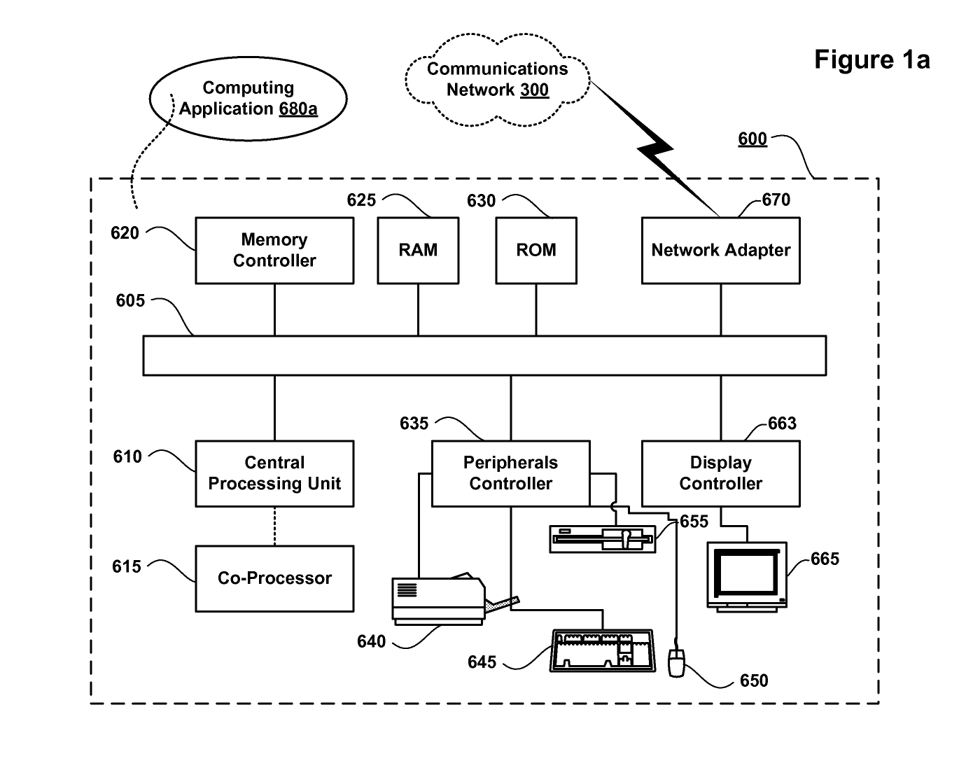

FIG. 1a depicts an exemplary computing system 600 in accordance with the invention. Computing system 600 executes an exemplary computing application 680a for providing computation services in accordance with the invention. Exemplary computing system 600 is controlled primarily by computer-readable instructions, which may be in the form of software, wherever, or by whatever means such software is stored or accessed. Such software may be executed within central processing unit (CPU) 610 to cause data processing system 600 to do work. In many known workstations and personal computers central processing unit 610 is implemented by a single-chip CPU called a microprocessor. Coprocessor 615 is an optional processor, distinct from main CPU 610, that performs additional functions or assists CPU 610. One common type of coprocessor is the floating-point coprocessor, also called a numeric or math coprocessor, which is designed to perform numeric calculations faster and better than general-purpose CPU 610. Recently, however, the functions of many coprocessors have been incorporated into more powerful single-chip microprocessors.

In operation, CPU 610 fetches, decodes, and executes instructions, and transfers information to and from other resources via the computer's main data-transfer path, system bus 605. Such a system bus connects the components in computing system 600 and defines the medium for data exchange. System bus 605 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 610. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 605 include random access memory (RAM) 625 and read only memory (ROM) 630. Such memories include circuitry that allow information to be stored and retrieved. ROMs 630 generally contain stored data that cannot be modified. Data stored in RAM 625 can be read or changed by CPU 610 or other hardware devices. Access to RAM 625 and/or ROM 630 may be controlled by memory controller 620. Memory controller 620 may provide an address translation function that translates virtual addresses into physical addresses as instructions are executed. Memory controller 620 also may provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 600 may contain peripherals controller 635 responsible for communicating instructions from CPU 610 to optional peripherals, such as, printer 640, keyboard 645, mouse 650, and disk drive 655.

Display 665, (optional), is controlled by display controller 663, is used to display visual output generated by computing system 600. Such visual output may include text, graphics, animated graphics, and video. Optional Display 665 may be implemented with a CRT-based video display, an LCD-based flat-panel display, gas plasma-based flat-panel display, or a touch-panel. Display controller 663 includes electronic components required to generate a video signal that is sent to display 665.

Further, computing system 600 may include at least one network adapter 670 which is used to connect computing system 600 to communication network 300. Communications network 300 may provide computers with means of communicating and transferring software and information electronically. Additionally, communications network 300 may provide distributed processing, which involves several computers and the sharing of workloads or cooperative efforts in performing a task. It will be appreciated that the network connections shown are exemplary and other means of establishing a communications link between the computers may be used.

### Federated Authorization

As noted above, the computer described with respect to FIG. 1a can be deployed as part of a computer network. In general, the above description applies to both server computers and client computers deployed in a network environment. FIG. 1b illustrates an exemplary network environment, with one or more server computers (exemplified by servers 310a, 310b, etc.) in communication with client computers 320a, 320b, etc. via a communications network 300, in which the present invention may be employed.

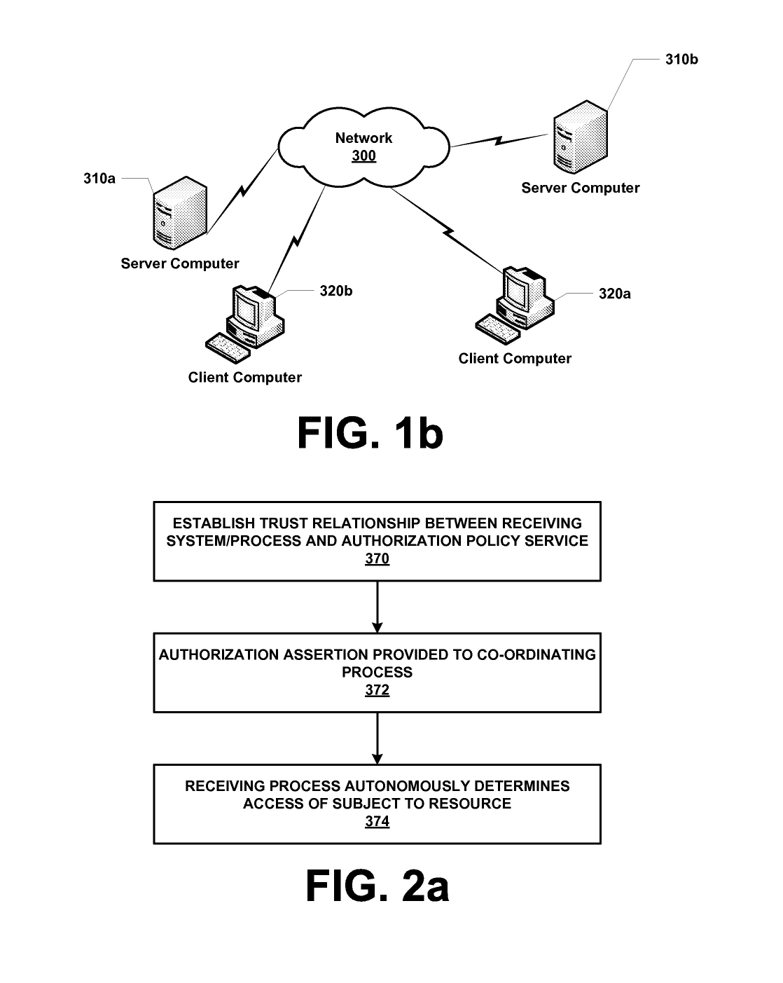

FIG. 2a illustrates a method of federated authorization in accordance with embodiments of the invention. At 370, a trust relationship is established between a receiving process and an authorization policy service. The trust relationship between the servicing process and the authorization provider may be established by registering a public or private key of a public/private key pair or a symmetric key of the authorization provider with the servicing process. Other ways to establish a trust relationship between the authorization provider and the servicing processes include registering a certificate authority with the servicing process, installing a file on the receiving system, inputting or providing a set of characters to the receiving system or by any other means of informing the receiving system of data needed to establish trust with authorization policy service. Although a digital signature may be used, other asymmetric techniques such as encryption may also be utilized as long as the servicing process can verify that only the holder of the signer private key could possibly encrypt and/or sign the authorization metadata fragment. At 372 an authorization assertion is provided to a coordinating process, as described more fully elsewhere. At 374 a receiving process autonomously determines whether to grant or deny a request for access to a resource received from a requesting process, without accessing an authorization service or other external resource.

FIG. 2b illustrates an exemplary federated authorization system 200 in accordance with embodiments of the invention. System 200 may reside in whole or in part on one or more computers such as the one illustrated above with respect to FIGS. 1a and 1b. One or more of the computers of FIG. 2b may reside on or connect to a network as described above. One or more of the components of FIG. 2b may reside on the same computer or each component may reside on a different computer.

A system for providing federated authorization may include one or more of the following components: one or more clients, represented in FIG. 2b by client 201, etc., an identity management server 204 hosting an identity management service 205, an authorization policy server 207 hosting an authorization policy service 208, and one or more servers, represented by servers 212, etc. Servers 212, etc. in some embodiments of the invention represent a “server farm” topology with an unlimited numbers of servers. Client 201 may host a rich-client executable, process 1 202, such as for example, a payroll application. Process 1 202 may be required to collaborate with other systems or processes (e.g. process 2 213) on the same computer or on a different computer to be able to deliver desired functionality to users. For example, the payroll application may need to access a middle tier web service (represented in FIG. 2 by process 2 213 on server 212) to perform functions such as retrieve employee data, save employee data, create a time entry record, delete a time entry record, and so on. The middle tier web service may provide this functionality by exposing a set of stateless SOAP endpoints. SOAP stands for Simple Object Access Protocol. SOAP is a protocol for exchanging XML-based messages over computer networks, typically using HTTP. SOAP forms the foundation layer of the Web services stack, and provides a messaging framework on which additional abstract layers can be built. One common messaging patterns in SOAP is the Remote Procedure Call (RPC) pattern, in which one network node (the client) sends a request message to another node (the server), and the server immediately sends a response message to the client. It will be appreciated that although process 2 213 is depicted as a single process, it should be understood to represent one or more processes on one or more computers and these processes are not restricted to web services. Furthermore, it will be appreciated that each process may spawn additional processes and may split into or generate two or more threads, one of which performs the processing described.

When a request 211 is made from the process 1 202 on the client 201 to the web service (process 2 213) on the server 212, the web service should ensure that the operation being requested is allowed to be performed by the caller 202. Traditionally, the web service had to accept an authentication token from the caller (to identify “who the caller is”) and then had to call an authorization provider to check that the caller has authorization to perform the action requested. Alternatively, the middle tier web service could persist the set of authorization metadata in a database and then would have to retrieve the indicated set of data from the database for each call it received. In systems that only expose a single host, the authorization metadata could be held in memory, however, such a system is not scalable (the number of users is restricted to the number of users a single host could handle) and is not reliable because if the single host becomes unavailable, the system ceases to work.

In contrast, in accordance with embodiments of the invention, server 212, etc. represents a server farm in which none of the servers in the farm have to consult any external system to determine if the request is authorized. In some embodiments of the invention the servicing process may be disconnected from a network and may be presented with an authlet by means of a removable storage medium, typed in text, etc. In some embodiments of the invention, the rich-client application (process 1 202) collects authentication information from a user. The authentication information collected from the user may be a user name/password combination, a biometric scan, information from a smartcard, a certificate such as an X509 certificate, a SAML assertion or any other information or collection of data suitable for identification or which may represent an authenticated identity. Process 1 202 may have the data about the identity to be used to exchange data with external processes or it may possess only the credentials of the identity on whose behalf data will be exchanged with a collaborating process. It may possess a token representing its credentials either before or after an authentication step. If authentication has not been performed, process 1 202 may request a different process to authenticate the subject. For example, the client may send a request for an authentication token 203 to an authentication provider. In some embodiments of the invention, the authentication provider is an identity management service 205 hosted on an identity management server 204. The identity management service 205 may receive the request for the authentication token 203 and the authentication credentials of the user and may perform one or more authentication steps that may access or enlist services from any number of external authentication providers (not shown) and may return an authentication token 206 to the requester (process 1 202).

An authorization policy service 208 on the authorization policy server 207 may be bundled with the authentication provider/identity management service (thereby enabling both authentication and authorization to be performed with a single call) or may be decoupled from the authentication provider. The authorization policy service 208 in some embodiments is an authorization provider that determines the authorization metadata to be returned to the requester. The authorization policy service may receive the data associated with a subject's authorization privileges and individually wrap each statement with a digital signature. Obtaining authorization metadata may involve consulting a database, a directory server, etc. (not shown). The authorization policy service 208 may assemble the authorization metadata into a plaintext authorization document and may sign sub-elements of the document as described above. For example, the following sample authorization verbs (authorization data fragments) may be individually digitally signed by the authentication policy provider:

“can retrieve an employee record”

“can retrieve employee record 123”

“can enter time record for employees 500 through 700”

Each digitally signed data fragment may be referred to as an authlet. Authorization policy service 208 in some embodiments assembles the signed data fragments into an authorization assertion for the subject and sends the authorization assertion 210 to the requester (e.g., process 1 202) in response to a request for an authorization assertion 209. The entire authorization assertion may also be signed and the signed authorization assertion may be sent to the requester. The requester may persist the authorization assertion to disk and/or maintain the authorization assertion in memory on client 201. In other embodiments of the invention, the authorization assertion is sent to an alternative destination specified by the requester. When the client 201 intends to make a stateless call to a server such as server 212, the client 201 may examine the authorization assertion, select the signed authorization fragment or authlet that corresponds to the operation being requested and send the selected authlet to the server 212. The digitally signed authorization data fragment may represent an authorization key for the action or data being requested by process 1 202. The authlet may be sent either as a parameter or as a header element to a web service together with the request for action encoded in request 211.

The web service may be configured to trust the signer (the authorization policy service), by having the public, private or symmetric key of the signer registered or by having a certificate trust chain relationship with the signer represented within a trusted certificate chain or by any other suitable means of establishing a trust relationship. If the web service (process 2 213) is configured to trust the signer, (e.g. the authorization policy service 208), the web service can autonomously evaluate the request and the authorization data fragment, verify the digital signature of the authlet and if the digital signature is determined to be valid and is determined to have been signed by a trusted system, the decrypted and/or verified authorization data may be used by the web service to determine whether to grant or deny access to the resource by applying the rule or rules specified in the authorization metadata of the decrypted and/or verified authlet. Process 2 213 may perform further processing based on the rule or rules in the authorization data fragment. For example, if process 2 213 is a web service that fetches data from an employee database and sends the data back to authorized callers, a method exposed by process 2 213 may expose a method called getEmployeeById (int Employee_id, string authlet). This method is of type Employee, which represents a complex type. Suppose process 1 202 is a web application that at an earlier point authenticated a user who submitted his credentials via the Internet using a web browser. Suppose the web application contacted an authentication provider that authenticated the user and provided an authentication token 206. The web application may then call the authorization policy service 208 on a machine 207 across the network, passing the authentication token for the user. Based on the authentication token 206, and/or on other criteria, the authorization policy service may create an assertion described in pseudo form below:

```
<assertion>
  <item name=”getEmployeeById” authlet=”(base64 encoding of the
  authlet)”/>
  <item name=”saveEmployeeRecord” authlet=”(base64 encoding
  of the authlet)” />
</assertion>
```

When the web application 202 is about to invoke the web service method “getEmployeeById” (of process 2 213), the necessary authlet or key is extracted by the web application 202 in order to successfully make the request. The web application 202 may look up getEmployeeById in the assertion document held by the application in a cookie or by any other storage means. The web application 202 may then call the web service method passing in the base64 encoded authlet which is associated with the action to be performed—in this case the execution of the method getEmployeeById. It will, of course, be appreciated that the action is not restricted to executing a method. The action may be calling a function, requesting a data element or range of data, or may be any other action or operation that can be described in terms of authorization.

When getEmployeeById or any filter put in front of the method, either on the same computer or on a different computer or security device, receives the request from the web application 202, it examines the value provided by the authlet. It validates the digital signature and determines whether it trusts the signer of the digital signature. If trusts exists between the web service (server) and the authorization policy service 208, the contents of the authlet are examined. In the example provided, suppose the cleartext embedded in the authlet is

<resource=“getEmployeeById” executeAllowed=“true”/>

Assuming that the authorization language is understood by both the authorization policy service 208 and the web service (process 2, 213), the web service will be able to safely execute the method getEmployeeById and return the requested information to the requesting process, process 1 202 because it will know that a trusted authorization provider gave the caller the “key” to perform the operation in question.

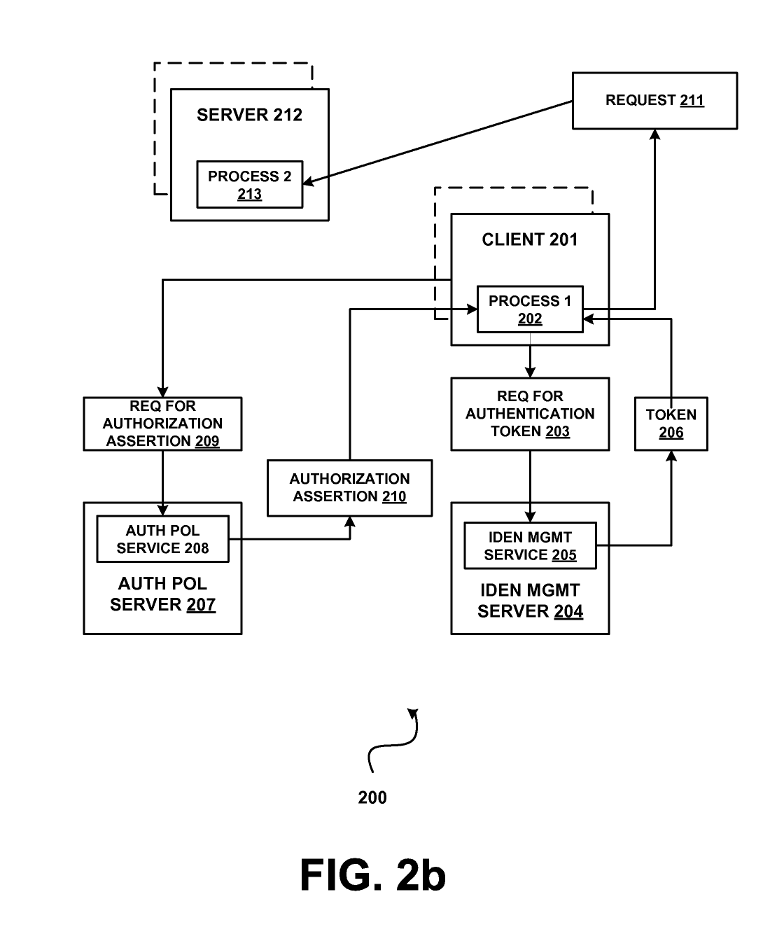

FIG. 3 is an illustration of establishing a trust relationship with the authorization policy service in accordance with embodiments of the invention. FIG. 3 illustrates an exemplary configuration in which a computing system or process 302 is required to be able to autonomously perform authorization decisions based on authorization assertions sent to it with requests for processing. A process 301, which may be a part of system 302 or may be external to system 302 communicates with authorization policy service 303, calling its GetPublicKey( ) method 304 which returns public key 306. It should be understood that the name of the method of 304 is merely an arbitrary name and its equivalent may be used. For example ObtainPK( ), or any other name may be used, as long as the method retrieves sufficient data from the authorization policy service 303 as to be useful for the process of establishing trust by systems that will utilize authorization assertions originating from the authorization policy service 303.

In response the authorization policy service 303 may return enough data so that trusting systems (represented in FIG. 3 by computing system or process 302) will be able to verify through the use of cryptographic algorithms the authenticity of any assertion generated by the authorization policy service 303. The system or process responsible for requesting the public key or other similar instrument from the authorization policy service 303, (e.g. coordination system or process 301) is responsible for calling the RegisterAuthorizationProvider( ) 305 method of the trusting computing system or process 302. It will be appreciated that the name RegisterAuthorizationProvider is arbitrary and any other name such as AddAuthSource( ), etc. may be used instead. When the call is made to RegisterAuthorizationProvider 305, the caller provides the data returned from authorization policy service 303, described above. Registering the authorization policy service causes system/process 302 to begin to trust any assertion generated from authorization policy service 303. Internally, system/process 302 may persist the public key or other similar instrument received in the RegisterAuthorizationProvider( ) method. In alternate embodiments of the invention trust may be established between authorization policy service 303 and system/process 302 by installing a file on system 302, or by inputting or providing a set of characters to system/process 302 or by any other means of informing system/process 302 of data needed to establish trust with authorization policy service 303. Typical examples include modifying configuration files, database tables, protected storage areas, etc. Of course RegisterAuthorizationProvider( ) 305 may and should itself verify the permissions of the caller (301) to ensure that it is allowed to add trusted authorization providers. It will be appreciated that other methods of establishing trust are contemplated and are included within the scope of the invention, as described herein.

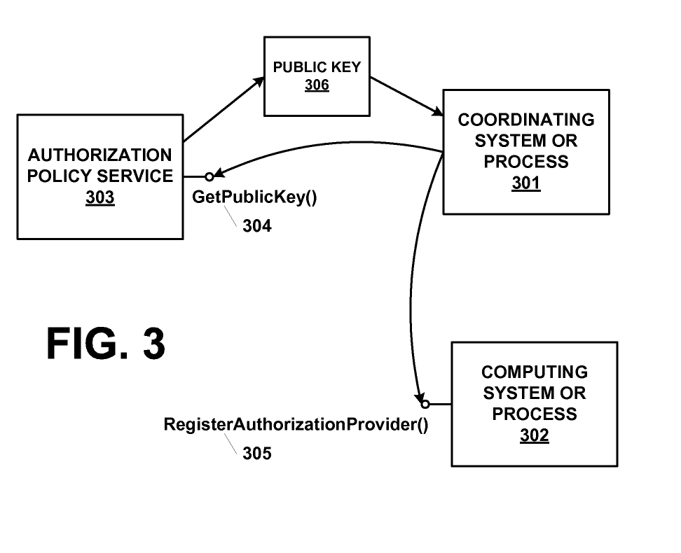

FIG. 4 illustrates an authorization assertion data structure in accordance with embodiments of the invention. In FIG. 4, an authorization assertion 401 is shown to contain within it one or more authlet envelopes 402. The authorization assertion 401 may be implemented using an XML encoding or it may be manifested by any other type of encoding such as binary encoding, a particular schema compliant with XML or in a completely proprietary or yet to be developed or invented format. The representation of the authorization assertion is purposely simplified and does not show other optional components which may be included such as the language used, authentication information, digital signature for the entire authorization assertion, validity times, asserting system identifier, and any other elements which may be added.

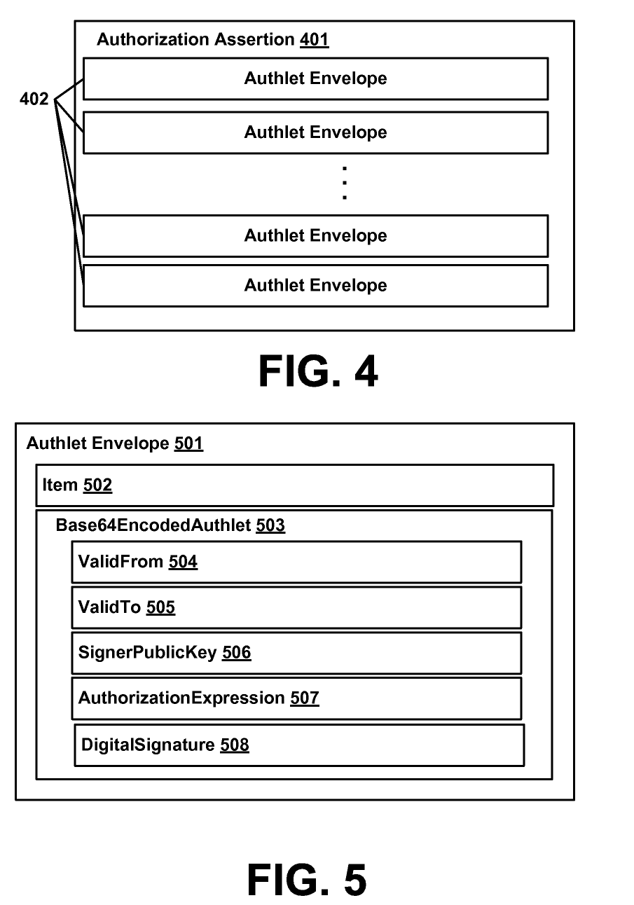

FIG. 5 illustrates an authlet envelope 501 in accordance with embodiments of the invention. The authlet envelope is shown to contain within it various elements or components. The authlet envelope may be implemented using XML or any other encoding methodology which can be understood by the relying and conveying software. Within authlet envelope 501 a data element, item 502 provides a way for the requesting process to find the authlet corresponding to the desired action within the array of all authlets contained within the authorization assertion. Within an embodiment of the present invention an authlet envelope may also contain sub-elements such as a base64 encoded representation of the authlet 503. In some embodiments the entire authlet can be encoded in a base64 character string. In other embodiments of the present invention any other encoding methodologies may be utilized. Within the authlet there may be additional data elements required to enable the relying process to make a determination about an authorization decision based on the authlet. The other elements which may be encapsulated within the base64 or other encoding methodology within the authlet include “valid from” data 504 which may include a date/time data field representing the date and time from which the authlet is valid, “valid to” data 505 which may be a date/time value representing the end date for the validity of the data represented by the authlet, “signer public key” 506 which may be represented as an array of bytes, either encoded in base64 or in another encoding methodology or raw collection of bytes that a relying servicing process can check against a list of trusted authorization providers or trust by virtue of a trust chain such as that of X509 certificates chaining or similar mechanism. Authorization expression 507 may represent a description of the authorization such as “allowed to click button” or “allowed to execute method only on certain conditions”, etc. The authorization expression 507 may be encoded by any language which is understood by the servicing process, including but not limited to SAML, XACML or other yet-to-be-developed authorization expression languages and schemas. The authlet of FIG. 5 includes a digital signature 508 which is the element which allows relying processes to verify the authenticity of the authlet. The digital signature may be produced by applying a cryptographic algorithm such as but not limited to DSA to the hash value produced from the complete contents of the authlet with the exclusion of the digital signature. A hash value of the elements of the authlet may be produced by applying a cryptographic algorithm such as but not limited to SHA-1 to the data contained in the authlet.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one network adapter. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for federated authorization comprising:
receiving a request for an authorization assertion for a subject at an authorization policy service from a requesting process, wherein the authorization policy service assembles the authorization assertion comprising at least one digitally signed authorization data fragment associated with the subject, wherein the authorization data fragment specifies metadata for access of the subject to a resource;
sending the authorization assertion to the requesting process, wherein the at least one digitally signed authorization data fragment is utilized by a servicing process for autonomous determination of authorization of the subject to access the resource based on a trust relationship between the authorization policy service and the servicing process.

2. The method of claim 1, wherein the authorization policy service is executed on a first computer and the requesting process is executed on a second computer different from the first computer.

3. The method of claim 1, further comprising receiving authorization information for the subject from an authorization provider and wrapping the received authorization information with a digital signature.

4. The method of claim 1, wherein the subject and a context is specified and the context comprises an application, service or executable.

5. The method of claim 1, wherein the authorization assertion as a whole is digitally signed.

6. The method of claim 1, wherein the trust relationship is based on digital signature algorithms.

7. The method of claim 1, wherein the trust relationship is based on symmetric or asymmetric encryption algorithms.

8. The method of claim 1, wherein the authorization assertion comprises a plurality of independently signed authorization data fragments embedded within an envelope having a queryable description to facilitate extraction of a particular signed authorization data fragment corresponding to a particular action or resource.

9. A system for federated authorization comprising:
a servicing process executing on a computer that receives a signed authorization data fragment comprising a symmetric or asymmetric encryption/decryption key for an encryption/decryption or digital signature algorithm and a request for access to a resource controlled by servicing process from a requesting process, wherein the servicing process autonomously determines authorization of the subject to the resource based on a trust relationship between the servicing process and a signer of the signed authorization data fragment.

10. The system of claim 9, wherein the servicing process autonomously determines authorization of the subject to the resource by processing the signed authorization data fragment and evaluating the contents of the signed authorization data fragment and verifying the validity of the digital signature and the trust relationship between the servicing process and the signer of the authorization metadata fragment.

11. The system of claim 9, wherein the subject comprises a person, a service, a role, a computer system, a computing process, a computing machine, an application or a computing entity.

12. The system of claim 9, wherein the signed authorization data fragment comprises metadata comprising authorization rules for access to a resource.

13. The system of claim 9, further comprising a requesting process on a client computer, wherein the requesting process requests an authorization assertion from an authorization policy service, the authorization assertion comprising a plurality of signed authorization data fragments specifying access authorizations of the subject to resources.

14. The system of claim 13, wherein the requesting process extracts a signed authorization data fragment corresponding to a specific action or resource from the authorization assertion and sends the extracted signed authorization data fragment corresponding to the specific action or resource to the servicing process.

15. A computer-readable storage medium comprising computer-executable instructions that when executed in a computing environment:
send a request to an authorization policy service for an authorization assertion for a subject; and
receive the authorization assertion from the authorization policy service, wherein the authorization assertion comprises at least one digitally signed authorization data fragment associated with the subject, wherein the authorization data fragment specifies authorization metadata associated with access of the subject to a resource.

16. The computer-readable storage medium of claim 15, comprising further instructions that when executed:
extract the at least one digitally signed authorization data fragment corresponding to a specific action from the authorization assertion.

17. The computer-readable storage medium of claim 15, comprising further instructions that when executed:
send the extracted digitally signed authorization data fragment corresponding to the specific action to a servicing process.

18. The computer-readable storage medium of claim 15, comprising further instructions that when executed:
extract the at least one digitally signed authorization data fragment corresponding to a specific action or resource from the authorization assertion based on a queryable envelope in which the at least one digitally signed authorization data fragment is embedded.

19. The computer-readable storage medium of claim 15, comprising further instructions that when executed:
request a key from the authorization policy service, wherein the key is a symmetric or asymmetric key for an encryption/decryption or digital signature algorithm.

20. The computer-readable storage medium of claim 19, comprising further instructions that when executed:
register the requested key with the servicing process.
